(19) United States
(12) Patent Application Publication
(10) Pub. No.: US 2004/0174391 A1
(43) Pub. Date: Sep. 9, 2004

(54) Apparatus, system and method of displaying a web page in a browser

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: Mr. Volel Emile, P.O. Box 202170, Austin, TX, 78720-2170, US

(73) Assignee: International Business Machines Corporation Armonk, New York

(21) Appl. No.: 10/383,841

(22) Filed: Mar. 6, 2003

(51) Int. Cl. G09G 5/00

(52) U.S. Cl. 345/743; 345/749

(57) ABSTRACT

A system, apparatus and method of displaying a Web page accessed via a link are provided. The system, apparatus and method display the Web page by determining whether an opened browser session is locked. If the opened browser session is locked a new browser session is opened to display the Web page. Otherwise, the Web page is displayed in the opened browser session if it is so configured.

### BACKGROUND OF THE INVENTION

1. Technical Field

The present invention is directed to communications networks. More specifically, the present invention is directed to an apparatus, system and method of displaying web pages in Web browsers.

2. Description of Related Art

As is well known by now, the World Wide Web (WWW) or Internet is a system of servers that support documents formatted in Hyper Text Markup Language (HTML). HTML supports links to documents as well as to graphics, audio and video files. Links are references to documents from within other documents. Links allow a user to easily jump from one document or Web page to another with just a click of a mouse. Thus, a link is a very useful Internet navigational tool.

Web pages are ordinarily displayed in a browser. (A browser is a software application that is used to locate and display Web pages). When a user accesses a new Web page via a link embedded in a displayed Web page, depending on the configuration, a new browser session may or may not open to display the new Web page. If a new browser session is not opened, an opened browser session is used to display the new Web page. In some instances, a user may not realize that a previously opened browser session is used to display the new Web page. For example, if the user only had one browser session opened, the user would ordinarily be aware of whether or not a new browser session is opened to display the new Web page. But, if the user has more than one browser session opened, the user may not be aware that an already opened browser session is used to display the new Web page.

In cases where the user is not aware that an opened browser session is used to display the new Web page and the user wants to continue viewing the old Web page, the user may spend quite some time looking for that Web page before realizing that it has been replaced by the new Web page. Further, upon realizing that the old Web page has been replaced by the new Web page, the user may re-access the old Web page using a newly opened browser session. When this is done, the Web page will be displayed at its beginning. Thus, if the user had previously scrolled down to a passage of interest, the user may have to spend additional time searching for that passage again.

Hence, what is needed is an apparatus, system and method of ensuring that a Web page is displayed into an opened browser session only if the user so desires.

### SUMMARY OF THE INVENTION

The present invention provides a system, apparatus and method of displaying a Web page accessed via a link. The system, apparatus and method display the Web page by determining whether an opened browser session is locked. If the opened browser session is locked, a new browser session is opened to display the Web page. Otherwise, the Web page may be displayed in the opened browser session.

In one particular embodiment, the system, apparatus and method determine whether the system is configured to use already opened browser sessions to display Web pages. If so, an opened browser session is used to display the Web page if the opened browser session is unlocked. If the system is not configured to use opened browser sessions to display Web pages, a newly opened browser session is used to display the Web page.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a representative graphical user interface (GUI) of a Web browser.

FIG. 5 is a lock drop down menu.

FIG. 6 is flow diagram of a process used by the present invention.

### DETAILED DESCRIPTION OF THE PREFERRED EMBODIMENT

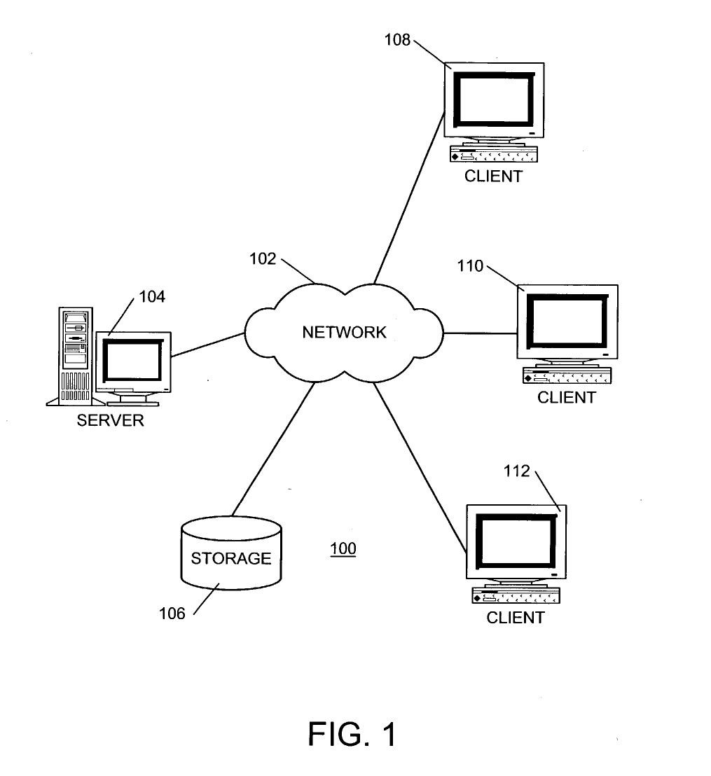

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

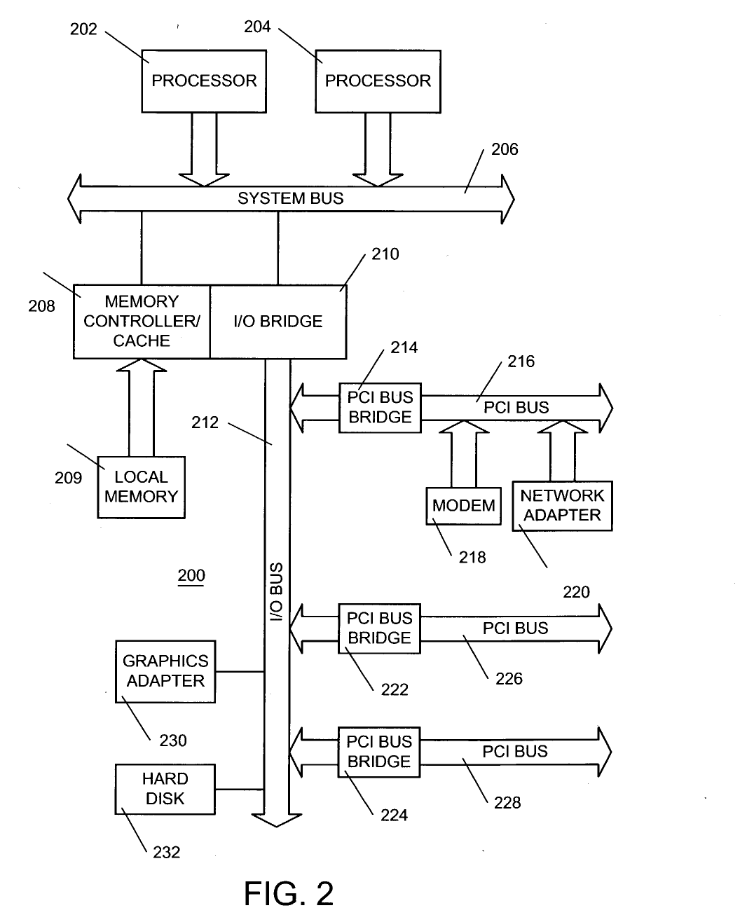

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pseries system, a product of International Business Machines Corporation in Armonk, N.Y., running the Advanced Interactive Executive (AIX) operating system or LINUX operating system.

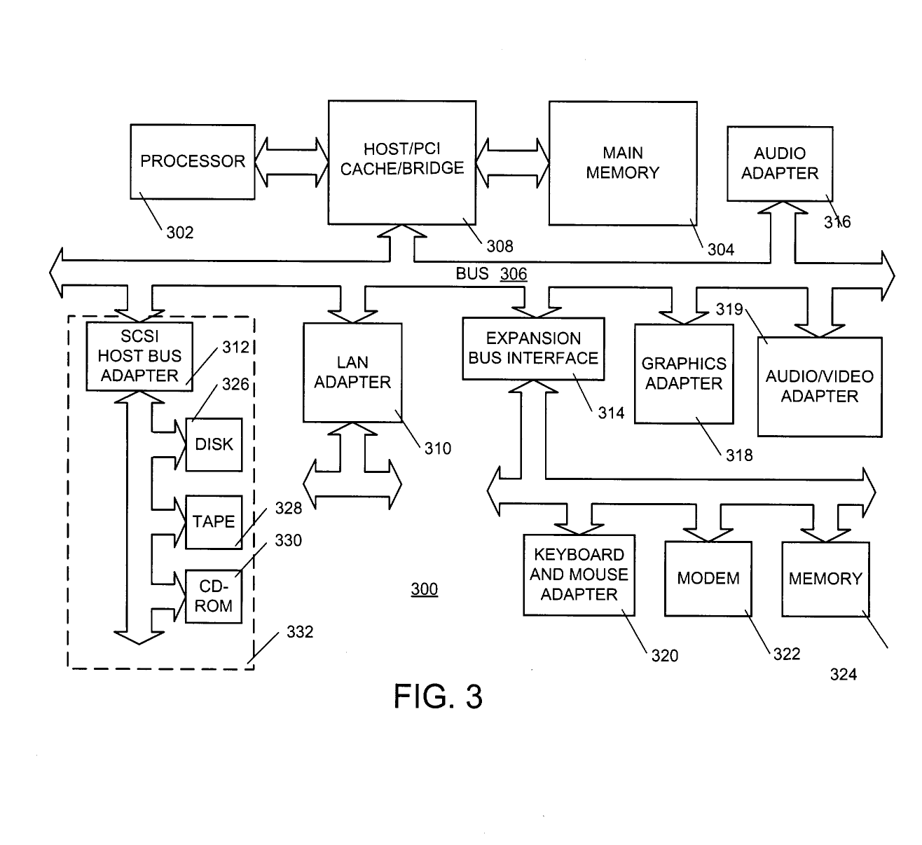

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus, system and method of locking a Web page into a browser session. The invention may be local to client systems 108, 110 and 112 of FIG. 1 or to the server 104 or to both the server 104 and clients 108, 110 and 112 and may reside on any data storage medium (i.e., floppy disk, compact disk, hard disk, ROM, RAM, etc.) used by a computer system.

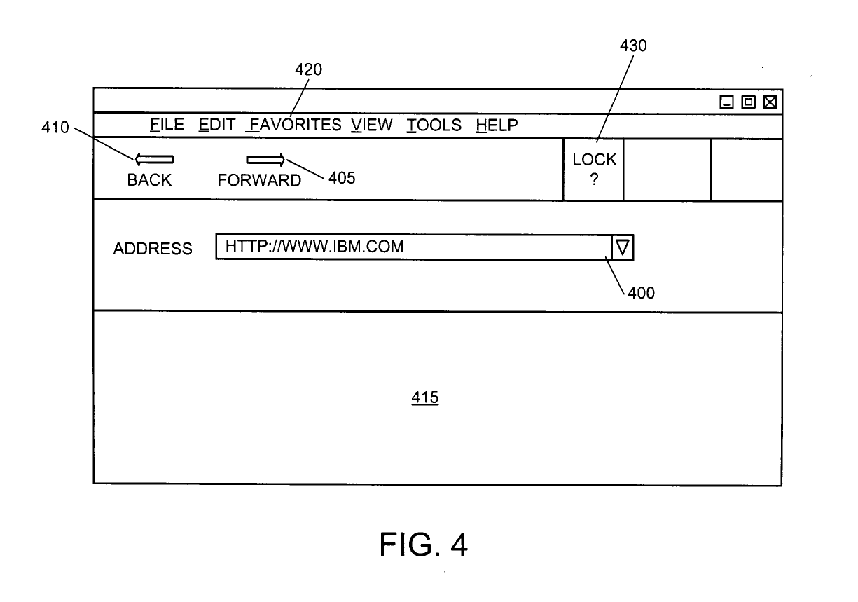

FIG. 4 is a representative graphical user interface (GUI) of a Web browser. Not all items in the GUI are shown and only the items of importance to the invention are given a reference numeral. When a Web browser session is opened and a Web page is accessed, the content of the page is displayed in area 415, the address or URL of the page is displayed in address box 400. Back arrow 410 and forward arrow 405 are not live (i.e., a user cannot assert them to get to a Web page). If another Web page is accessed, the URL of the displayed page will be displayed in address box 400 and the content in area 415. The back arrow 410 will become live. If the user asserts back arrow 410, the previous page will be re-displayed along with its pertinent information (i.e., URL, content etc.). At that time, forward arrow 405 will become live, back arrow 410 will not be live. If a user accesses three different Web pages successively, and while the third page is displayed returns to the second page using the back arrow 410, both back arrow 410 and forward arrow 405 will be live. The user may assert back arrow 410 to re-display the first Web page or forward arrow 405 to re-display the third Web page. This is made possible by caching or storing the URLs in a memory device (not shown) in the order the Web pages were accessed. Note that, if a new Web page is accessed while the second Web page is displayed, the URL of the new page will be cached replacing the URL of the third page. Caching URLs of Web pages is a well-known art and is thus not explained.

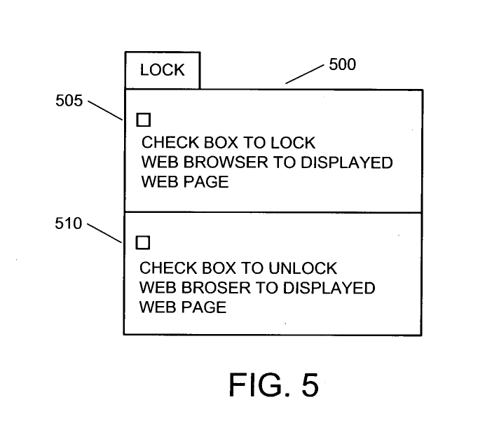

FIG. 4 also includes a lock item 430. When a user asserts the lock item 430, FIG. 5 is displayed. The user may assert the lock item 430 by clicking on a button of a pointing device such as a mouse, for example, when the cursor of the pointing device is over the item 430.

FIG. 5 is a lock drop down menu 500. Lock drop down menu 500 has two boxes (boxes 505 and 510). Only one of the boxes may be checked at a time. Thus, the check mark may toggle between the two boxes 505 and 510. However, box 510 may be used (i.e., checked) as a default setting. In any case, when box 505 is checked, the browser session is locked to the Web page that is presently displayed. When box 510 is checked, the browser session is unlocked.

To lock the browser session to a presently displayed Web page is to inhibit a new Web page from being displayed in the opened Web session. For example, Web pages that are accessible through links in e-mail messages or in embedded Web pages or a word processing document etc. may not be displayed in the locked browser session. However, Web pages accessed through the back arrow 410, forward arrow 405 or through addresses entered into address box 400 will be displayed in the locked browser session as customary.

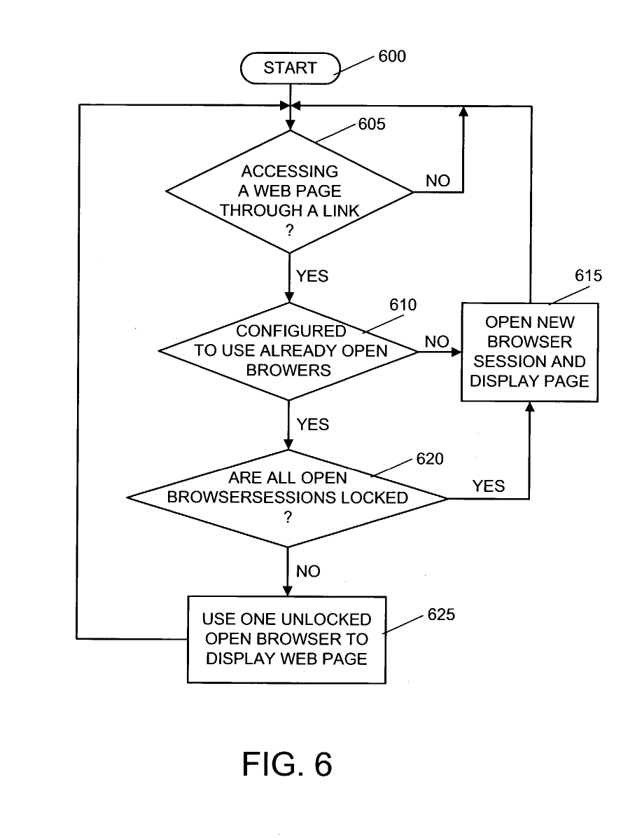

FIG. 6 is a flow diagram of a process that may be used by the present invention. The process starts as soon as a Web browser session is opened (step 600). A check is continuously being made to determine whether a new Web page is being accessed through a link. The link, as mentioned above, may be embedded in a displayed Web page, an e-mail message, a word processing document etc. If a new Web page is being accessed through a link, another check is made to determine whether the system is configured to use an already opened browser session to display the new Web page. If not, a new browser session is opened to display the new Web page and the process returns to step 605 (steps 605, 610 and 615).

If the system is configured to use an already opened browser session to display the new Web page, another check is made to determine whether all the browser sessions that are opened are locked. If so, the process jumps back to step 615. If not, an unlocked browser session is used to display the new Web page and the process returns to step 605(steps 610, 620 and 625).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of displaying a Web page accessed via a link comprising the steps of:
determining whether an opened browser session is locked; and
displaying the Web page in a newly opened browser session if the opened browser session is locked otherwise displaying the Web page in the opened browser session.

2. The method of claim 1 wherein the determining step includes a step of determining whether the system is configured to use opened browser sessions to display Web pages.

3. The method of claim 2 wherein if the system is not configured to use opened browser sessions to display Web pages a newly opened browser session is used to display the Web page.

4. The method of claim 3 wherein if the system is configured to use opened browser sessions to display Web pages an opened browser session is used to display the Web page if the opened browser session is unlocked.

5. The method of claim 4 wherein the link may be embedded in a displayed Web page, in an e-mail message or in a word processing document.

6. An apparatus for displaying a Web page accessed via a link comprising:
means for determining whether an opened browser session is locked; and
means for displaying the Web page in a newly opened browser session if the opened browser session is locked otherwise displaying the Web page in the opened browser session.

7. The apparatus of claim 6 wherein the determining means includes means for further determining whether the system is configured to use opened browser sessions to display Web pages.

8. The apparatus of claim 7 wherein if the system is not configured to use opened browser sessions to display Web pages a newly opened browser session is used to display the Web page.

9. The apparatus of claim 8 wherein if the system is configured to use opened browser sessions to display Web pages an opened browser session is used to display the Web page if the opened browser session is unlocked.

10. The apparatus of claim 9 wherein the link may be embedded in a displayed Web page, in an e-mail message or in a word processing document.

11. A computer program product on a computer readable medium for displaying a Web page accessed via a link comprising:
code means for determining whether an opened browser session is locked; and
code means for displaying the Web page in a newly opened browser session if the opened browser session is locked otherwise displaying the Web page in the opened browser session.

12. The computer program product of claim 11 wherein the determining code means includes code means for further determining whether the system is configured to use opened browser sessions to display Web pages.

13. The computer program product of claim 12 wherein if the system is not configured to use opened browser sessions to display Web pages a newly opened browser session is used to display the Web page.

14. The computer program product of claim 13 wherein if the system is configured to use opened browser sessions to display Web pages an opened browser session is used to display the Web page if the opened browser session is unlocked.

15. The computer program product of claim 14 wherein the link may be embedded in a displayed Web page, in an e-mail message or in a word processing document.

16. A system for displaying a Web page accessed via a link comprising:
at least one storage device for storing code data; and
at least one processor for processing the code data to determine whether an opened browser session is locked, and to display the Web page in a newly opened browser session if the opened browser session is locked otherwise displaying the Web page in the opened browser session.

17. The system of claim 16 wherein the processor further processes the code data to determine whether the system is configured to use opened browser sessions to display Web pages.

18. The system of claim 17 wherein if the system is not configured to use opened browser sessions to display Web pages a newly opened browser session is used to display the Web page.

19. The system of claim 18 wherein if the system is configured to use opened browser sessions to display Web pages an opened browser session is used to display the Web page if the opened browser session is unlocked.

20. The system of claim 19 wherein the link may be embedded in a displayed Web page, in an e-mail message or in a word processing document.
